(19) United States
(12) Patent Application Publication
(10) Pub. No.: US 2018/0194260 A1
(43) Pub. Date: Jul. 12, 2018

(54) SYSTEM FOR DUMP BODY HEATING AND TEMPERATURE CONTROL

(71) Applicant: Crysteel Manufacturing Inc., Lake Crystal, MN (US)

(72) Inventor: Larry Dunker, North Mankato, MN (US)

(21) Appl. No.: 15/849,843

(22) Filed: Dec. 21, 2017

Related U.S. Application Data
(60) Provisional application No. 62/444,772, filed on Jan. 10, 2017.

(51) Int. Cl. B60P 1/28

(52) U.S. Cl. CPC B60P 1/286

(57) ABSTRACT

A system for heating a dump body is provided. The system may include a diverter, a controller, dump body ductwork, and a first temperature sensor. The diverter may be configured to direct exhaust to an exhaust stack conduit, to a dump body conduit, or both, based on a position of the diverter. The controller may be configured to control the position of the diverter via an actuator. The dump body ductwork may be configured to receive exhaust from the dump body conduit and provide heat from the exhaust to the dump body. The first temperature sensor may be configured to provide a first measurement of temperature of the dump body or a payload of the dump body to the controller. The controller may be configured to control the position of the diverter in a non-binary manner based on a comparison of the first measurement of temperature with a target temperature or a target temperature range. A method for controlling exhaust distribution to dump body ductwork is also provided.

This application claims priority to co-pending U.S. Provisional Patent Application Ser. No. 62/444,772, filed on Jan. 10, 2017, the disclosure of which is herein incorporated by reference in its entirety.

### TECHNICAL FIELD

This disclosure relates to systems and methods for heating and maintaining a desired temperature or temperature range of a dump body.

### BACKGROUND

As is known in the art, it is desirable to provide heating to dump bodies of dump trucks or similar vehicles. Such dump bodies may typically comprise steel or aluminum and heating may be desirable, for example, when hauling hot asphalt to keep it hot and when hauling materials in cold weather to prevent payloads from freezing to the dump body. When hauling hot asphalt, it may desirable to maintain the temperature of the asphalt in, for example, the 275° F. to 325° F. range. When hauling snow or ice or other materials that have a risk of freezing to the dump body, it may be desirable to maintain the dump body temperature above freezing.

Some existing dump body heating systems use exhaust diverters to heat a dump body using exhaust from a truck engine. Such existing systems control the exhaust diverter in a binary manner; that is, the exhaust diverter may be controlled to be either on—wherein the dump body is heated by exhaust, or off—wherein the exhaust does not flow through the dump body, but is rather routed to the exhaust stack.

Early versions of such systems included a manually controlled diverter box, which required an operator to move a lever on the diverter box to direct exhaust to the body. Often, this required the operator to exit the cab of a truck to affect such control. In some of these early versions, a diverter box had an over-center spring to hold the diverter box in either position. Later dump body heating systems improved upon these early versions by adding an air cylinder to the diverter box and an air valve in the cab, allowing the operator to control the exhaust diverter from inside the cab. Some versions were further enhanced by replacing the air valve in the cab with an electrical switch and including a solenoid-operated air valve near the air cylinder.

Following the issuance of emissions regulations in 2007, diesel particulate filters (DPF) and catalytic converters replaced mufflers in the exhaust systems. As is commonly known and practiced in the industry, DPFs are “regenerated” to extend their working life. During regeneration, fuel is injected into a DPF and ignited to burn the collected soot, thereby cleaning the DPF. However, during regeneration, exhaust temperatures could rise to between 1000° F. and 1300° F. These high temperatures would burn paint and could anneal the steel used in dump bodies.

To protect the dump body from these high regeneration temperatures, temperature switches or temperature sensors and thermostats were added to air cylinder equipped exhaust diverter systems. In such systems, temperature sensors or switches were mounted (1) to the exhaust pipe between the DPF and the diverter box, (2) to the exhaust pipe between the diverter box and the body, or (3) to exhaust ducting on the body. If the measured temperature was lower than a particular target temperature, then the exhaust would be routed to the body; when the measured temperature exceeded the target temperature, the exhaust would be routed out the exhaust stack. In this way, potential damage to the heating system, the dump body, or its payload from over-heated exhaust gas could theoretically be prevented.

There are, however, drawbacks to such existing temperature-based existing systems. Where the temperature sensor is located (1) between the DPF and the diverter box and the target temperature was lower than the normal exhaust temperature, exhaust would rarely, if ever, be routed to the body, precluding body heating. On the other hand, if the target temperature was increased to be higher than normal exhaust temperature, the risk of overheating the dump body (and causing, e.g., paint damage) due to excessive exhaust being directed to the dump body became a problem.

Mounting a temperature sensor at or around location (2) between the diverter box and the body or location (3) on ducting in the body, may avoid the above-described problem associated with temperature sensors located (1) between the DPF and the diverter box. However, with temperature measurements made at or around locations (2) or (3), the actual exhaust temperature may diverge from the measured temperature due to cooling as exhaust passes through various system components. Thus, when the actual exhaust temperature exceeded the target temperature, such systems have a tendency oscillate between routing exhaust to the body and routing exhaust out the stack. In turn, this sometimes caused undesirable noise and/or excessive wear on system components. Beyond this, such dump body heating systems had limited temperature controls due to the fact that exhaust was routed to a single destination at a time—either to the dump body for heating or out the exhaust stack.

Thus, there is a need for a dump body heating and temperature control system that may efficiently maintain the dump body in a desired temperature or temperature range. A system meeting such a need may prevent, for example, hot asphalt or another hauled payload from being overheated or allowed to cool too much, damage to the dump body or the heating system, excessive noise, and/or excessive system wear.

### SUMMARY

The present disclosure provides a description of dump body heating and temperature control systems to address the perceived needs described above.

In one example, a system for heating a dump body is provided. The system may include a diverter, a controller, dump body ductwork, and a first temperature sensor. The diverter may be configured to direct exhaust to an exhaust stack conduit, to a dump body conduit, or both, based on a position of the diverter. The controller may be configured to control the position of the diverter via an actuator. The dump body ductwork may be configured to receive exhaust from the dump body conduit and provide heat from the exhaust to the dump body. The first temperature sensor may be configured to provide a first measurement of temperature of the dump body or a payload of the dump body to the controller. The controller may be configured to control the position of the diverter in a non-binary manner based on a comparison of the first measurement of temperature with a target temperature or a target temperature range.

The system may further include a dump body position sensor. The dump body position sensor may be configured to provide an indication of whether the dump body is raised to the controller. The controller may be further configured to control the position of the diverter as to direct all exhaust to an exhaust stack conduit if the dump body is raised.

The controller may be further configured to control the position of the diverter as to direct more exhaust to the exhaust stack conduit and less exhaust to the dump body conduit if the dump body is not raised and the first measurement of temperature is above the target temperature or the target temperature range. The controller may be further configured to control the position of the diverter as to direct less exhaust to the exhaust stack conduit and more exhaust to the dump body conduit if the dump body is not raised and the first measurement of temperature is below the target temperature or the target temperature range.

The controller may be further configured to control the position of the diverter as to direct more exhaust to the exhaust stack conduit and less exhaust to the dump body conduit if the dump body is not raised and the first measurement of temperature is above the target temperature range. The controller may be further configured to control the position of the diverter as to direct less exhaust to the exhaust stack conduit and more exhaust to the dump body conduit if the dump body is not raised and the first measurement of temperature is below the target temperature range. The controller may be further configured to control the position of the diverter by maintaining a current position of the diverter if the dump body is not raised and the first measurement of temperature is within the target temperature range.

The controller may be further configured to control the position of the diverter control the position of the diverter in an average increment of not more than 9 or 22.5 rotational degrees when the dump body is not raised.

The first temperature sensor may be mounted on the dump body. The first temperature sensor may by located within three feet of the distribution box of the dump body ductwork. The first temperature sensor may be mounted on the dump body ductwork. The first temperature sensor may be an infrared sensor and the first measurement of temperature may be of a payload of the dump body

The target temperature—or the bounds of the target temperature range—may be between 275° F. and 325° F., 50° F. and 100° F., or 100° F. and 200° F. A first bound and second bound of the target temperature range may between 275° F. to 325° F.

The controller may be further configured to select the target temperature or the target temperature range based on an input regarding characteristics of the payload of the dump body.

The actuator may be a linear actuator or a rotary actuator.

The system may further include a first zone duct of the dump body ductwork, a second zone duct of the dump body ductwork, a second temperature sensor, and a first zone diverter. The first zone duct may be configured provide heat from the exhaust to a first zone of the dump body. The second zone duct may be configured provide heat from the exhaust to a second zone of the dump body. The second temperature sensor may be configured to provide a second measurement of temperature of the second zone of the dump body to the controller. The first zone diverter may be configured to regulate exhaust provided to the first zone duct. The first measurement of temperature may be of the first zone of the dump body. The controller may be further configured to control the position of the diverter based on a comparison of the first measurement and the second measurement with the target temperature or the target temperature range. The controller may be further configured to control the position of the first zone diverter based on a comparison of the first measurement with the target temperature or the target temperature range.

In another example, a method for controlling exhaust distribution to dump body ductwork is provided. The method may include receiving exhaust from an engine and determining whether a dump body is raised. If the dump body is raised, the method may include directing all exhaust to an exhaust stack. If the dump body is not raised, the method may include repeatedly performing at least the following three steps: (1) comparing a measurement of temperature of the dump body or payload of the dump body with a target temperature or a target temperature range; (2) if the measurement of temperature is lower than the target temperature or the target temperature range, directing more the received exhaust to the dump body ductwork by a first incremental flow amount; and (3) if the measurement of temperature is greater than the target temperature or the target temperature range, directing less of the received exhaust to the dump body ductwork by a second incremental flow amount. The first and second incremental flow amounts may each be less that a total flow amount of the received exhaust.

### BRIEF DESCRIPTION OF THE DRAWINGS

The accompanying drawings, which are incorporated into and constitute a part of this disclosure, illustrate several embodiments and aspects of the systems, and methods described herein and, together with the description, serve to explain the principles of the invention.

FIGS. 1-5 are schematic diagrams of a system for dump body heating and control in various states, consistent with disclosed embodiments.

FIG. 6 is a schematic diagram of a portion of system for dump body heating and control that is configured to provide different amounts of exhaust heat to different zones of the dump body, consistent with disclosed embodiments.

FIG. 7 is an illustration of an exemplary truck with a dump body and system for dump body heating and control, consistent with disclosed embodiments. Portions are shown with additional detail.

FIG. 8 is an illustration of an exemplary dump body and system for dump body heating and control, consistent with disclosed embodiments. Portions are shown with additional detail

FIG. 9 is flow chart of an example of an algorithm to effectuate dump body heating and temperature control in accordance with exemplary embodiments.

FIG. 10 is an illustration of an exemplary diverter box with actuator, consistent with disclosed embodiments.

FIG. 11 is an illustration of an exemplary spring box, consistent with disclosed embodiments.

FIG. 12 is an illustration of an exemplary temperature sensor, consistent with disclosed embodiments.

### DETAILED DESCRIPTION

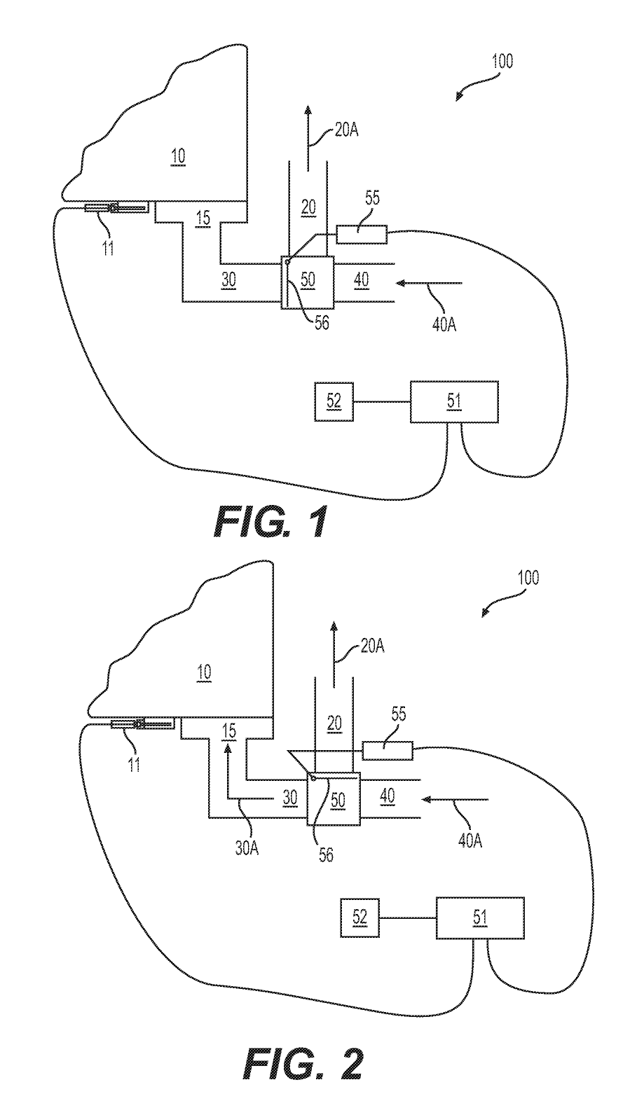

As depicted in FIGS. 1-5, a system 100 for dump body heating and control may include diverter box 50, controller 51, user interface 52, a diverter 56, temperature sensor 11, linear or rotary actuator 55, dump body conduit 30, exhaust input conduit 40, exhaust stack conduit 20, and exhaust body ductwork 15. Exhaust input conduit 40 may receive exhaust from an engine 40 (not shown) and direct it towards diverter 56. Received exhaust is depicted at flow 40A, exhaust directed through dump body conduit 30 is depicted as flow 30A, and exhaust directed through exhaust stack conduit 20 is depicted as flow 20A. Diverter 56 and diverter box 50 may direct the received exhaust to exhaust stack conduit 20, dump body conduit 30, or partially to each conduit 20, 30 based on its position. Exhaust stack conduit 20 may direct exhaust to an exhaust stack 21. Dump body conduit 30, may direct exhaust to dump body ductwork 15, where the exhaust may be circulated to heat the dump body. After such circulation, the exhaust may be released into the atmosphere. One or more temperature sensors 11 may determine the temperature of the dump body or its contents at one or more locations, and resulting temperature data may be provided to controller 51.

Controller 51 may also receive data from a dump body position sensor 13 (not shown), which may indicate the position of the dump body—e.g., whether it is raised or lowered; from a user via user interface 52; and/or from the vehicle to which the dump body is attached, or the vehicle's respective controller(s) thereof. Controller 51 may control actuator 55, which may control the position of diverter 56, ultimately directing the exhaust to the appropriate conduit(s) 20, 30. Via user interface 52, a user may input a desired target temperature or target temperature range. Based on the target temperature and the temperature data from, temperature sensor(s) 11, the controller may, via actuator 55 and diverter 56, direct more, less, or the same amount of exhaust to flow through dump body ductwork 15 in order to cause the temperature of dump body 10 to be increased or reduced.

Controller 51 may be any type of microprocessor chip or chips, or computing device suitable for performing the functions and algorithms disclosed herein. Such functions or algorithms may be embodied in software run by controller 51 and may be stored in volatile or non-volatile memory within or otherwise associated within controller 51. In some embodiments controller 51 be configured to perform other functions related to the operation or performance of an associated dump body, vehicle, or the like.

System 100 may be turned off—and all exhaust may be routed through exhaust stack conduit 20—whenever dump body 10 is raised to dump its payload. Further, controller 51 may be configured to turn off system 100, either automatically or via instruction through user interface 52 when dump body 10 is empty or when it is not desired that the payload be maintained at an elevated temperature or otherwise heated. In some embodiments, controller 51 may be programmed to automatically place system 100 in an “off” configuration after dump body 10 has been raised and lowered—presumably emptying its payload. In other embodiments, controller 51 may be programmed to maintain system 100 in an “on” configuration by default after dump body 10 has been raised and lowered; the may accommodate for situations where it is desirable to keep the dump body warm, for example, where it will receive a new payload in the near future, and/or in situations where payload was only partially emptied.

In some embodiments, temperature sensor(s) 11 may be located at or near to the distribution box (where the exhaust enters dump body ductwork 15), for example, within 3 feet, 2 feet, 1 foot, or 6 inches from the distribution box, or distances there between. In some embodiments, temperature sensor(s) 11 may be located on or in or on the floor, side, or front of dump body 10. In certain embodiments, temperature sensor(s) 11 may be affixed directly to the steel or aluminum material comprising dump body 10 and/or dump body ductwork 15. In other embodiments, the temperature sensor(s) 11 may comprise one or more infrared sensors mounted, for example, near the top of the front of dump body 10 or on the vehicle, to measure the temperature of the payload in lieu of or in addition to directly measuring the temperature of the dump body 10.

FIG. 1 depicts system 100 wherein the system is turned off. As shown, diverter 56 is positioned as to direct all exhaust received from the engine 41 (if any) via exhaust input conduit 40 to the exhaust stack 21 via exhaust stack conduit 20.

FIG. 2 depicts system 100 wherein the system is on and all exhaust is routed through dump body conduit 30 into dump body ductwork 15 to heat dump body 10 and its contents as rapidly as possible. A display of user interface 52 may display the target temperature (or target temperature range), the temperature of the dump body 10, and/or other temperature(s) indicated by temperature sensor(s) 111. The display may also provide an indication of the position of diverter 56.

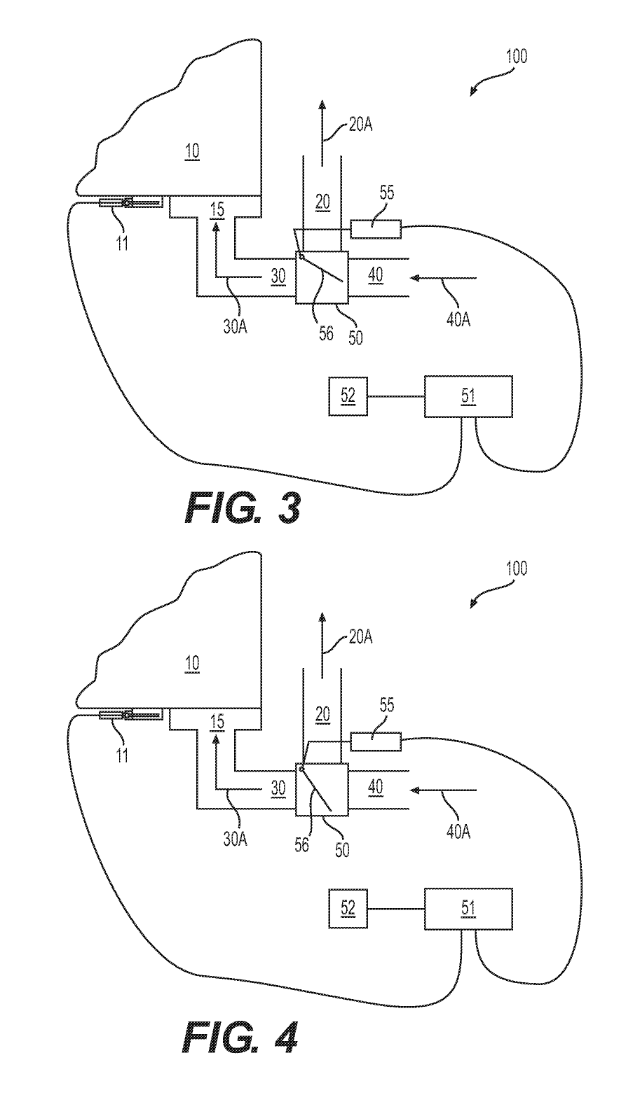

FIG. 3 depicts system 100 wherein the system is on and a large fraction of the exhaust is routed through dump body conduit 30 into dump body ductwork 15 to heat dump body 10 and its contents. Here, controller 51 may have compared received temperature data from temperature sensor(s) 11 to the target temperature, and determined that less than all of the available exhaust is needed to maintain or achieve the target temperature or temperature range. Controller 51 may adjust actuator 55 to move diverter 56 as to cause an appropriate fraction of exhaust to be utilized to heat dump body 10. The remainder of the exhaust may flow to the exhaust stack 21 via exhaust stack conduit 20.

FIG. 4 depicts system 100 wherein the system is on and a smaller fraction of the exhaust is routed through dump body conduit 30 into dump body ductwork 15 to heat dump body 10 and its contents. FIG. 4 is similar to FIG. 3. FIG. 3 may be understood to depict a typical diverter 56 position where a higher dump body 10 temperature is desired, as compared to FIG. 4.

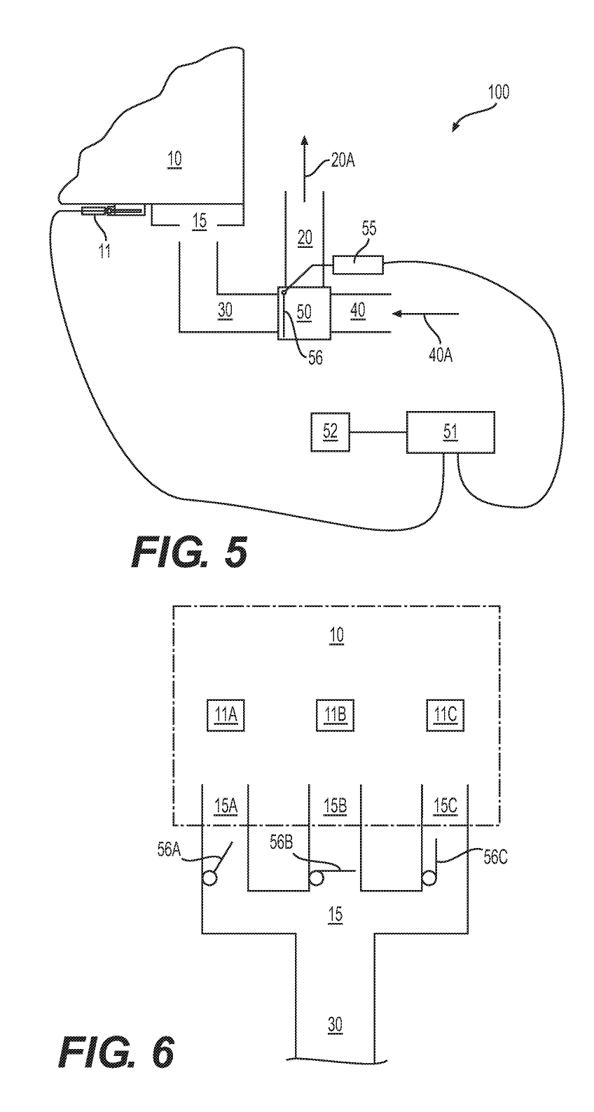

FIG. 5 depicts system 100 wherein dump body 10 is raised. As known in the art, when dump body 10 is raised, dump body conduit 30 may be automatically separated from dump body ductwork 15. Thus, in this circumstance, regardless of whether the system is otherwise on or off, it may be desirable that diverter 56 to maintain a position that directs all exhaust received from the engine 41 (if any) via exhaust input conduit 40 to the exhaust stack 21 via exhaust stack conduit 20.

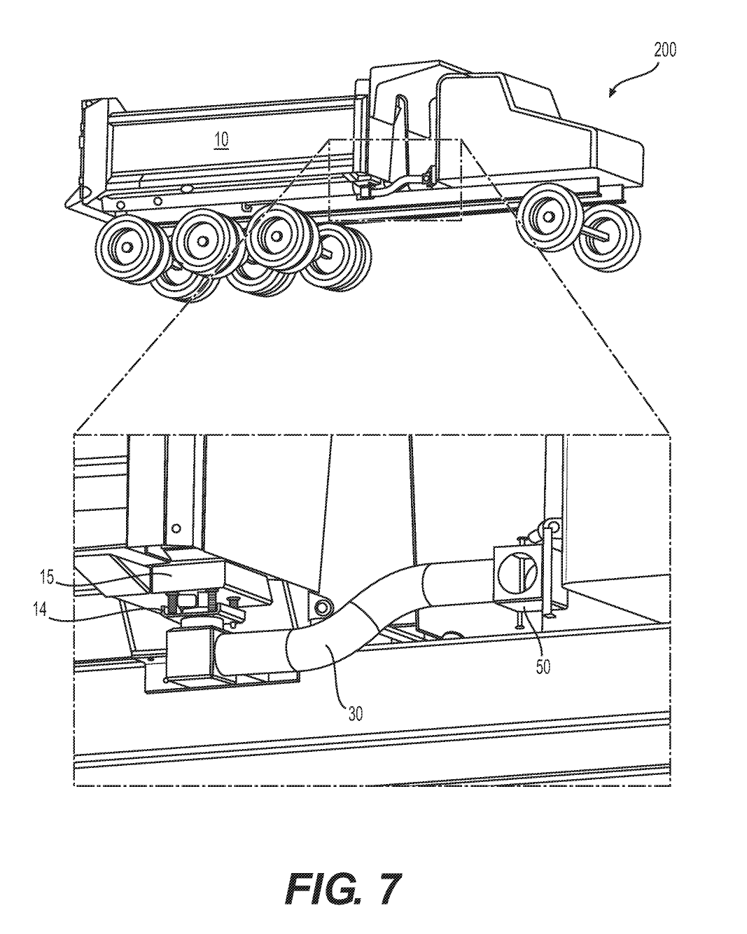

FIG. 7 illustrates a dump truck with system for dump body heating and control 200. As shown, diverter box 50 may be coupled to the engine exhaust output near the cab of the truck. Dump body conduit 30 may direct exhaust from diverter box 50 to dump body ductwork 15 via spring box 14. Spring box 14 serves to absorb the impact from the raising and lowering of the dump body and to reduce or eliminate exhaust that might result from a partial misalignment of a lowered dump body or the like. In some embodiments, dump body position sensor 13 may be installed on or within spring box 14.

FIG. 11 depicts an exemplary spring box 14 in further detail.

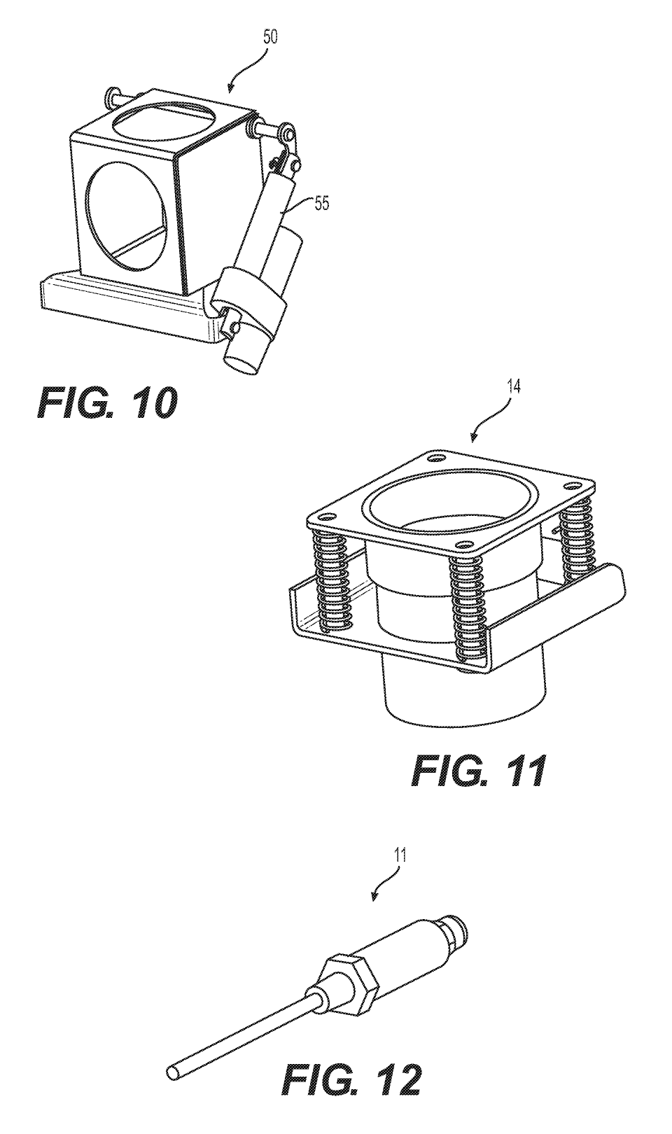

FIG. 10 depicts an exemplary diverter box 50 with actuator 55. In some embodiments, the diverter box may include an input port sized to match a particular exhaust pipe size of a particular vehicle's exhaust input conduit 40. For example, the diverted box may have an exhaust input port configured to receive and engage with a 5 inch diameter exhaust pipe (as is common in many trucks) or a 4 inch diameter exhaust pipe (as is common in Mack® Trucks). In preferred embodiments, exhaust stack conduit 20 and dump body conduit 30 and their respective output ports in diverter box 50 would match the size of the input port and exhaust input conduit 40.

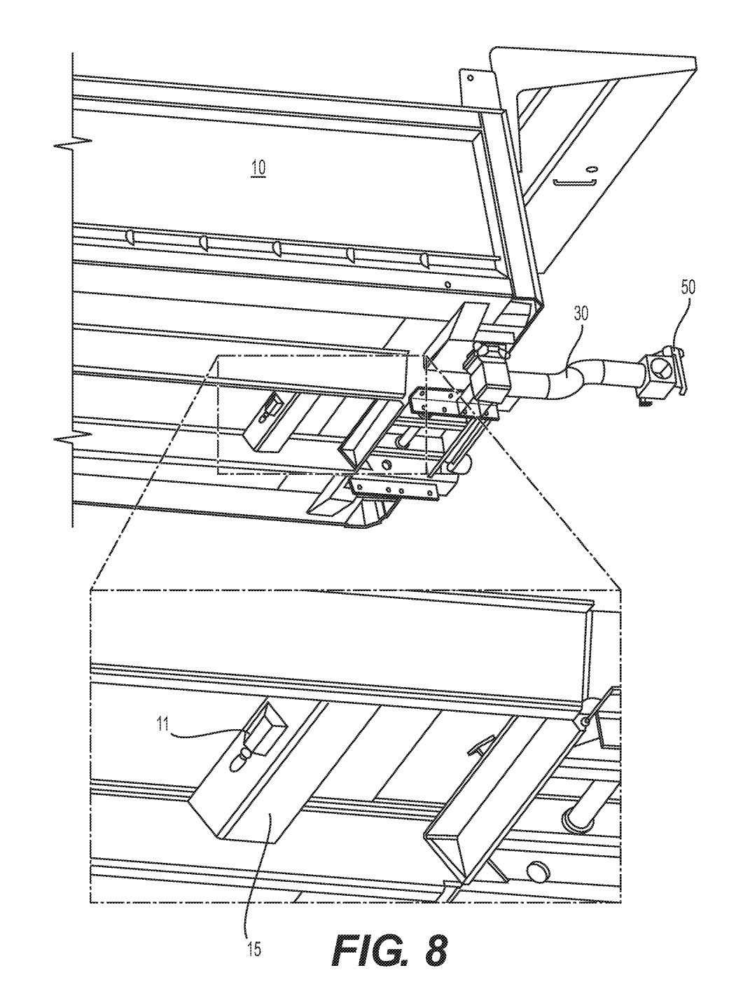

FIG. 8 illustrates dump body 10 and system for dump body heating and control 100. Temperature sensor 11 is depicted installed in an exemplary location on dump body ductwork 15.

FIG. 12 depicts an exemplary temperature sensor 11 in further detail.

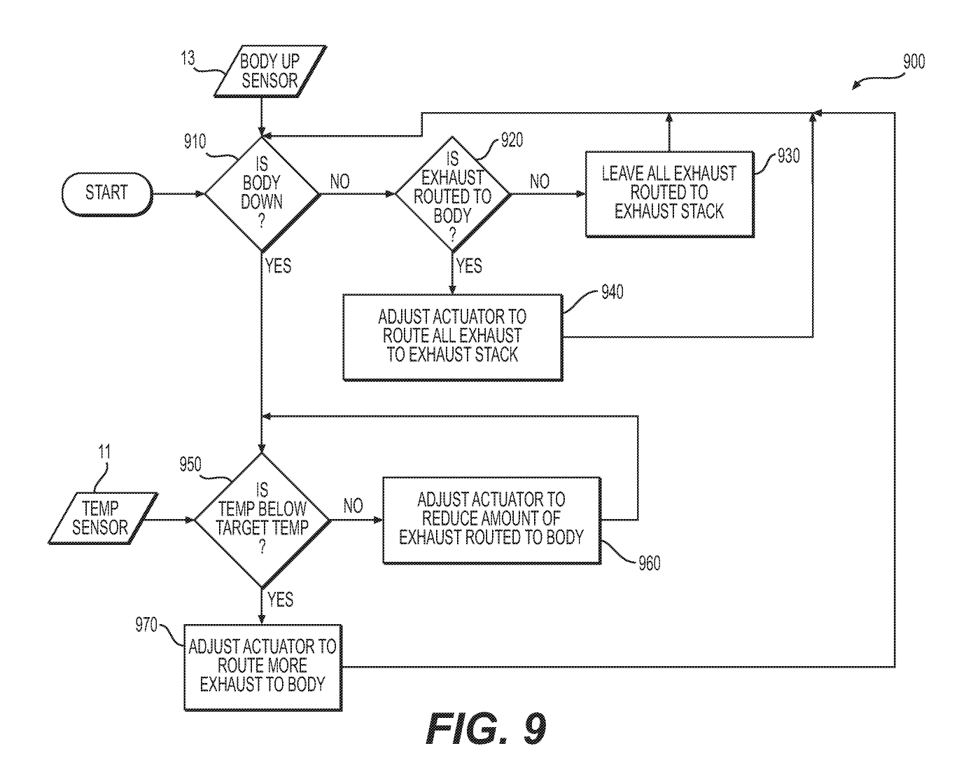

FIG. 9 illustrates process 900, an embodiment of an algorithm for running system 100. The steps of this algorithm (as well as other alternative and related algorithms referred herein) may be performed by controller 51, in concert other elements of system 100. As would be apparent to persons of skill in the art, the exact order of certain steps of the disclosed algorithm embodiment may be altered while still practicing the disclosed algorithms. Similarly, certain steps of the disclosed algorithm embodiments may be substituted, combined, or removed while still practicing the disclosed algorithms—consistent with the disclosure herein and/or as would be apparent to persons of skill in the art.

As in step 910, received data from dump body position sensor 13 is assessed to determine if the dump body is in a down position. If the dump body is down, the process proceeds to step 950; if not, the process proceeds to step 920.

As in step 920, it is determined whether any exhaust is currently being routed to through dump body conduit 30. If not, all exhaust is currently being routed to exhaust stack 20 and such routing is maintained, as in step 930; then, the process proceeds back to step 910. If any exhaust is currently being routed to through dump body conduit 30, the process proceeds to step 940.

As in step 940, diverter 56 is adjusted via actuator 55 such that all exhaust is will be routed to exhaust stack 20. Then, the process proceeds back to step 910.

As in step 950, received data from temperature sensor 11 is assessed and compared to a target temperature. For hauling snow or ice, the target temperature may preferably be set to a value between 50° F. and 100° F., or more preferably between 50° F. and 75° F. Such target temperatures may prevent excessive amounts of undesirable melting while avoiding freezing and ensuring optimal dump body operation. For hauling wet sand, clay, or gravel in cold weather, the target temperature may preferably be set to a value between 100° F. and 200° F. And, for hauling hot asphalt, the target temperature may preferably be set to a value between 275° F. and 325° F. If the assessed temperature is below the target temperature, the process may proceed to step 970; if not, the process may proceed to step 960. In some embodiments, an operator may directly select or input a target temperature or target temperature range via user interface 52. In some embodiments, an operator may indirectly select a target temperature or target temperature range by indicating the payload characteristics. In other embodiments, a target temperature or target temperature range may be preset automatically or by a manager, supervisor, or other individual or system associated with initial placement of a payload in dump body 10.

As in step 960, actuator 55 may be controlled such that diverter 56 directs less exhaust through dump body conduit 30 (reducing flow 30A) and more exhaust through exhaust stack conduit 20 (increasing flow 20A). In this manner, less exhaust is directed to dump body ductwork 15, ostensibly reducing the temperature of dump body 10. The process then proceeds back to step 950.

In preferred embodiments, diverter 56 is only slightly moved during each step 960. For example, in one embodiment, an actuator may be extended or retracted in 5 mm increments. This may result in an average of 9 rotational degrees of diverter 56 movement per increment, with approximately 8 degrees of movement per increment when diverter 56 is centrally located and approximately 10 degrees of movement when diverter 56 is located at one of the ends of its range. Thus in some embodiments, it may be preferred that the average increment is not more than 9 rotational degrees. In other preferred embodiments, each rotational increment may range from an average of 4.5 of rotational degrees (e.g., 21 positions) to an average of 22.5 rotational degrees (e.g., 5 positions). Thus in some embodiments, it may be preferred that the average increment is not more than 22.5 rotational degrees. While average increments of more than 22.5 degrees and greater may be considered to offer temperature control that is more coarse than desired, this disclosure is contemplates average rotational increments of up to 45 degrees (e.g., 3 positions). Similarly, while average increments of less than 4.5 degrees may offer little relative functional improvement when the required mechanical precision and associated cost is considered, this disclosure is contemplates average rotational increments down to 0.5 degrees.

As in step 970, actuator 55 may be controlled such that diverter 56 directs more exhaust through dump body conduit 30 (increasing flow 30A) and less exhaust through exhaust stack conduit 20 (reducing flow 20A). In this manner, more exhaust is directed to dump body ductwork 15, ostensibly increasing the temperature of dump body 10. In preferred embodiments diverter 56 movement in step 970 may proceed in similar increments as discussed with respect to step 960, above. The process then proceeds back to step 910.

In preferred embodiments, one single cycle of process 900 when body 10 is down may take approximately 5 to 50 seconds. Such cycles may be repeated more frequently when the temperature difference between body 10 and a target temperature is larger and less frequently when the temperature difference is smaller. For example, in preferred embodiments, where the difference is 10° F. or greater, diverter 56 may be adjusted approximately every 5 seconds; where the difference is 1° F. or less, diverter 56 may be adjusted approximately every 50 seconds. However, cycle lengths between 1 second and 5 minutes may be suitable and are contemplated by this disclosure.

In alternative embodiments, the target temperature may be a range of temperatures (which in yet other embodiments may be defined as a target temperature with upper and lower thresholds). In such embodiments, a step similar to step 950 may ask whether the assessed temperature is within the target temperature range, above it, or below. If above the target range, the alternative process may proceed to step 960. If below the target range, the alternative process may proceed to step 970. If within the target range, the alternative process may simply proceed back to step 910 without adjusting actuator 55 or the position of diverter 56.

FIG. 6 illustrates an alternative embodiment wherein system 100 may be further configured to transfer different amounts of exhaust heat to different zones of dump body 10. Here, system 100 may include multiple temperature sensors 11, for example, temperature sensors 11A, 11B, and 11C, each configured to provide temperature data for a particular zone of dump body 10, or portion of a payload thereof. Dump body ductwork 15 may include zone ducts, for example, 15A, 15B, and 15C, configured to heat respective zones of dump body 10 with exhaust. The passage of exhaust through each of the zone ducts 15A, 15B, 15C may by controlled via zone diverters, for example, 56A, 56B, and 56C, respectively. Zone diverters 56A, 56B, 56C, may be individually controlled to adjust the flow of the exhaust through the zone ducts 15A, 15B, 15C in order to equalize the temperatures at each temperature sensor 11A, 11B, 11C locations. In alternative embodiments (not shown), a single zone diverter may be used vary the flow of exhaust through two adjacent zone ducts.

Temperature data from temperature sensors 11A, 11B, 11C may be provided to controller 51 and zone diverters 56A, 56B, 56C, may be controlled by controller 51, for example via respective linear or rotary actuators (not shown). In this manner, a target temperature or temperature range may be maintained in each of the zones of dump body 10. When exhaust in not needed in any zone of dump body 10, diverter 56 may divert all exhaust to exhaust stack conduit 20, for example, as shown in FIG. 1. It is contemplated that all zones may share a target temperature or temperature range in some embodiments. In this manner, system 100 may provide more uniform temperatures throughout dump body 10. However, in alternative embodiments, a user may set a different target temperature or temperature ranges for each zone via user interface 52. The flow 30A of exhaust to each respective zone duct 15A, 15B, 15C may be controlled by controller 51 in a manner similar to that of process 900 or its alternatives.

As shown in FIG. 6, zone diverter 56A is partially opened to allow some exhaust to flow through zone duct 15A to heat or maintain a temperature of a first zone of dump body 10. Zone diverter 56B is entirely closed to prevent the provision of exhaust through zone duct 15B and the consequent heating of a second zone of dump body 10. Zone diverter 56C is entirely opened to allow substantial exhaust to flow through zone duct 15C to heat a third zone of dump body 10.

In another alternative embodiment, a system for dump body heating and control for may utilize electric heaters for heating a dump body 10 instead of exhaust. Such alternative system may be comprised of one or more electric heaters, for example 12 VDC electric heaters; an equal number of temperature sensors 11; a programmable controller 51 and a user interface 52. The electric heater(s) may be mounted to the underside of dump body 10. Additional heaters may be mounted to the sides and to the front of dump body 10. Temperature sensors 11 may be placed near each heater. Controller 51 may use the input from the temperature sensors 11 to turn each heater on and off in order to maintain a target temperature or target temperature range. As discussed above with respect to system 100, the target temperature or temperature range may be set via user interface 52. In yet other embodiments, one or more temperature sensors 111 may comprise one or more infrared temperature sensors mounted on dump body 10 or vehicle, for example, near the top of the front, to measure the temperature of the payload.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the appended claims. It is also to be understood that the terminology used herein is for the purpose of describing particular aspects only, and is not intended to be limiting, since the scope of the present invention will be limited only by the appended claims.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto and additional embodiments may be implemented without departing from the broader scope of the claims that follow. The specification and drawings are accordingly to be regarded in an illustrative rather than restrictive sense.

We claim:

1. A system for heating a dump body, comprising:
a diverter configured to direct exhaust to an exhaust stack conduit, to a dump body conduit, or both, based on a position of the diverter;
a controller, the controller configured to control the position of the diverter via an actuator;
dump body ductwork configured to receive exhaust from the dump body conduit and provide heat from the exhaust to the dump body; and
a first temperature sensor, the first temperature sensor configured to provide a first measurement of temperature of the dump body or a payload of the dump body to the controller,
wherein the controller is configured to control the position of the diverter in a non-binary manner based on a comparison of the first measurement of temperature with a target temperature or a target temperature range.

2. The system of claim 1, further comprising:
a dump body position sensor, the dump body position sensor configured to provide an indication of whether the dump body is raised to the controller,
wherein the controller is further configured to control the position of the diverter as to direct all exhaust to an exhaust stack conduit if the dump body is raised.

3. The system of claim 2, wherein:
the controller is further configured to control the position of the diverter as to direct more exhaust to the exhaust stack conduit and less exhaust to the dump body conduit if the dump body is not raised and the first measurement of temperature is above the target temperature or the target temperature range; and
the controller is further configured to control the position of the diverter as to direct less exhaust to the exhaust stack conduit and more exhaust to the dump body conduit if the dump body is not raised and the first measurement of temperature is below the target temperature or the target temperature range.

4. The system of claim 6, wherein:
the controller is further configured to control the position of the diverter as to direct more exhaust to the exhaust stack conduit and less exhaust to the dump body conduit if the dump body is not raised and the first measurement of temperature is above the target temperature range;
the controller is further configured to control the position of the diverter as to direct less exhaust to the exhaust stack conduit and more exhaust to the dump body conduit if the dump body is not raised and the first measurement of temperature is below the target temperature range; and
the controller is further configured to control the position of the diverter by maintaining a current position of the diverter if the dump body is not raised and the first measurement of temperature is within the target temperature range.

5. The system of claim 3, wherein:
the controller is further configured to control the position of the diverter in an average increment of not more than 22.5 rotational degrees when the dump body is not raised.

6. The system of claim 3, wherein:
the controller is further configured to control the position of the diverter in an average increment of not more 9 rotational degrees when the dump body is not raised.

7. The system of claim 4, wherein:
the controller is further configured to control the position of the diverter in an average increment of not more than 22.5 rotational degrees when the dump body is not raised.

8. The system of claim 4, wherein:
the controller is further configured to control the position of the diverter in an average increment of not more than 9 rotational degrees when the dump body is not raised.

9. The system of claim 1, wherein the first temperature sensor is mounted on the dump body.

10. The system of claim 9, wherein the first temperature sensor is located within three feet of a distribution box of the dump body ductwork.

11. The system of claim 9, wherein the first temperature sensor is mounted on the dump body ductwork.

12. The system of claim 1, wherein the first temperature sensor is an infrared sensor and the first measurement of temperature is of a payload of the dump body.

13. The system of claim 1, wherein the target temperature is between 275° F. and 325° F. or a first bound and second bound of the target temperature range are between 275° F. and 325° F.

14. The system of claim 1, wherein the target temperature is between 50° F. and 100° F. or a first bound and second bound of the target temperature range are between 50° F. and 100° F.

15. The system of claim 1, wherein the target temperature is between 100° F. and 200° F. or a first bound and second bound of the target temperature range are between 100° F. and 200° F.

16. The system of claim 1, wherein the controller is further configured to select the target temperature or the target temperature range based on an input regarding characteristics of the payload of the dump body.

17. The system of claim 1, wherein the actuator is a linear actuator.

18. The system of claim 1, wherein the actuator is a rotary actuator.

19. The system of claim 1, further comprising:
a first zone duct of the dump body ductwork configured provide heat from the exhaust to a first zone of the dump body;
a second zone duct of the dump body ductwork configured provide heat from the exhaust to a second zone of the dump body;
a second temperature sensor, the second temperature sensor configured to provide a second measurement of temperature of the second zone of the dump body to the controller; and
a first zone diverter configured to regulate exhaust provided to the first zone duct, wherein:
the first measurement of temperature is of the first zone of the dump body;
the controller is further configured to control the position of the diverter based on a comparison of the first measurement and the second measurement with the target temperature or the target temperature range; and
the controller is further configured to control the position of the first zone diverter based on a comparison of the first measurement with the target temperature or the target temperature range.

20. A method for controlling exhaust distribution to dump body ductwork, comprising:
receiving exhaust from an engine;
determining whether a dump body is raised;
if the dump body is raised, directing all exhaust to an exhaust stack;
if the dump body is not raised, repeatedly,
comparing a measurement of temperature of the dump body or payload of the dump body with a target temperature or a target temperature range;
if the measurement of temperature is lower than the target temperature or the target temperature range, directing more the received exhaust to the dump body ductwork by a first incremental flow amount; and
if the measurement of temperature is greater than the target temperature or the target temperature range, directing less of the received exhaust to the dump body ductwork by a second incremental flow amount,
wherein the first and second incremental flow amounts are each less that a total flow amount of the received exhaust.
